(19) United States
(12) Patent Application Publication
(10) Pub. No.: US 2008/0088184 A1
(43) Pub. Date: Apr. 17, 2008

(54) POWER SUPPLY APPARATUS

(76) Inventors: CHUN-CHIN TUNG, Chupei (TW); Yung-Lieh Chien, Chupei (TW)

Correspondence Address: G. LINK CO., LTD, 3550 BELL ROAD, MINOOKA, IL, 60447, US

(21) Appl. No.: 11/856,028

(22) Filed: Sep. 15, 2007

(30) Foreign Application Priority Data
Oct. 17, 2006 (TW) 095138210

(51) Int. Cl. H02J 4/00

(52) U.S. Cl. 307/80

(57) ABSTRACT

A power supply apparatus is disclosed. The power supply apparatus comprises a determining device, an identifier, a multi-power-output selecting mechanism and a transmission mechanism, for selecting power in the form of varying voltage for outputting therefrom. Wherein the multi-power-output selecting mechanism is electrically connected to the determining device and the transmission mechanism, and the identifier is provided in the transmission mechanism so that the determining device outputs an electrical signal based on the corresponding identifier and transmits the electrical signal to the multi-power-output selecting mechanism. The multi-power-output selecting mechanism selects the converted power based on the output voltage signal corresponding to the electrical signal and outputs it via the transmission mechanism.

### FIELD OF THE INVENTION

The present invention relates to a power supply apparatus for selecting a power generation device for outputting power with multiple voltages and providing a transmission interface to an external load which is connected to the power generation device, and particularly to a power supply apparatus which may determine the transmission interface so as to convert the power of the power generation device to the corresponding output voltages.

### BACKGROUND OF THE INVENTION

It is a critical issue whether the output voltage interface of a conventional power supply apparatus is convenient or not. Although most of powers in the modern circuit system are conformed to standard specification, more and more specific circuits are used for requiring higher or lower power to meet the special purpose. Thus, it is important to have power selection and switch. However, it would cause partial or overall damage to the circuit device if the output power is incorrectly connected to the circuit device. Therefore, the present invention provides a multi-power-output selection mechanism in the power supply apparatus having automatic decision and switching feature to prevent the damage of circuit device from applying incorrect battery power and for time saving of confirming the correct power connected to apparatus.

Therefore, the present invention provides a power supply apparatus which can provide the selection of multiple voltage output to resolve the problem of the conventional power supply apparatus.

### SUMMARY OF THE INVENTION

Accordingly, the object of the present invention is to provide a multi-power-output selection mechanism which converts the power of a power generation device into the corresponding output voltage based on the voltage requirement of the external load.

Alternatively, another object of the present invention is to provide a determination device which provides the multi-power-output selection mechanism for identifying the voltage requirement of an external load so as to further select the converted output voltage.

Alternatively, yet another object of the present invention is to provide a transmission mechanism which provides a external load for electrically connecting to the power transmission channels of the power generation device, and the determination device is provided in the transmission mechanism for providing the multi-power-output selection mechanism to identify the voltage requirement of the external load so as to automatically select the power generation device for outputting voltage.

Alternatively, yet another object of the present invention is that the transmission mechanism further provides a selection means of identifier for selecting the equivalent resistance of the identifier and meeting the voltage requirement of the external load.

Alternatively, yet another object of the present invention is further to provide a selection means of identifier for selecting the equivalent resistance of the identifier and meeting the voltage requirement of the external load in the application of the mobile power of Fuel Cell or Li-ion battery.

The present invention provides a power supply apparatus for selecting a power generation device for outputting power in the form of varying voltage therefrom, comprises: a determination device, which at least includes an electrical element, the electrical element having a specific resistance which defines a signal corresponding to a specific output voltage; a multi-power-output selection mechanism, which includes a voltage output determination means for determining the specific resistance of the electrical element of the determination device and outputting the corresponding output voltage signal and a voltage output selection means for selecting a corresponding power transmission channel based on the output voltage signal; and a transmission mechanism for transmitting power output from the multi-power-output selection mechanism; wherein the voltage output determination means of the multi-power-output selection mechanism is electrically connected to the determination device and the voltage output selection means of the multi-power-output selection mechanism is electrically connected to the transmission mechanism so that the resistance from the determination device is transmitted to the voltage output determination means of the multi-power-output selection mechanism and output the specific output voltage signal to the voltage output selection means. The voltage output selection means includes a plurality of power transmission channels and transmits a specific output voltage to the transmission mechanism through the selected power transmission channel.

The aforesaid multi-power-output selection mechanism further comprises a plurality of voltage converters, each of which is electrically connected in series with a corresponding power transmission channel, for converting power transmitted from each power transmission channel into varying specific output voltage which each corresponds to the output voltage signal. Moreover, the voltage output selection means of the multi-power-output selection mechanism further comprises a plurality of switches which are electrically connected in series with a corresponding power transmission channels, respectively, and the multi-power-output selection mechanism selects ON/OFF of the power transmission channel based on the output voltage signal so that the voltage output selection means selects the corresponding power transmission channel. The voltage output determination means of the multi-power-output selection mechanism further comprises a microcontroller which is electrically connected in series between a analog-digital signal converter (A/D converter) and the voltage output selection means and outputs a signal corresponding to the voltage output selection means to switch on/off the corresponding switch.

Besides, the switch of the voltage output determination means of the multi-power-output selection mechanism can be replaced by a multiplexer, and the multiplexer includes a power input terminal electrically connected to the power generation device for inputting the output power of the power generation device; a control input terminal electrically connected to the A/D converter for inputting the digital control signal of the A/D converter; and a plurality of power output terminal; a microcontroller for receiving the digital signal output from the A/D converter and determining the corresponding output channel selected by the multiplexer based on this signal; wherein the multiplexer selects the power input terminal to electrically connected to a corresponding power output terminal based on the digital signal for selecting ON/OFF of the corresponding power transmission channel based on the output voltage signal, so that the voltage output selection means selects the corresponding power transmission channel.

The transmission mechanism further comprises a first transmitter and a second transmitter. The first transmitter comprises a first engagement part and the second transmitter comprises a second engagement part. The first engagement part is mechanically engaged with the second engagement part, and the first engagement part and the second engagement part are configured to form a pair of connectors capable of electrical interface and mechanical coupling. The first transmitter is electrically connected to the power output terminal of the multi-power-output selection mechanism, and the second transmitter transfers the power to the external load through electrically interfacing the first engagement part with the second engagement part.

The determination device is provided in the second transmitter of the transmission mechanism, and further comprises a plurality of identifiers electrically connected each other in parallel, the plurality of identifiers are resistors, each of which has a specific resistance, and an equivalent resistance formed of the plurality of resistors defines a corresponding signal to a specific output voltage. Besides, the determination device further comprises a selection means of identifier and a switching means of identifier. The selection means of identifier is to select electrical conduction for each identifier so that the selected identifiers with electrical conduction are formed to an equivalent resistance; and the switching means of identifier is to select for turning on or off the switch of identifier to adjust the equivalent resistance of the identifier.

In order to make those skilled in the art understand the objects, features and advantages of the present invention, the following embodiments with reference to the accompanying diagrams will be provided herein for describing the present invention.

### BRIEF DESCRIPTION OF THE DRAWINGS

FIG. 1 is a schematic relational diagram of a power supply apparatus of the invention;

FIG. 2 is a schematic block diagram of a first embodiment of the power supply apparatus of the invention;

FIG. 2 is a schematic block diagram of a first embodiment of the power supply apparatus of the invention;

FIG. 3 is a schematic block diagram of a second embodiment of the power supply apparatus of the invention;

FIG. 4 is a schematic block diagram of a third embodiment of the power supply apparatus of the invention;

FIG. 5 is a schematic block diagram of a fourth embodiment of the power supply apparatus of the invention;

FIG. 6 is a schematic block diagram of a fifth embodiment of the power supply apparatus of the invention;

FIG. 7 is a schematic block diagram of a sixth embodiment of the power supply apparatus of the invention;

FIG. 8 is a schematic block diagram of a seventh embodiment of the power supply apparatus of the invention;

FIG. 9 is a schematic block diagram of an eighth embodiment of the power supply apparatus of the invention; and

FIG. 10 is a schematic block diagram of a ninth embodiment of the power supply apparatus of the invention.

### DETAILED DESCRIPTION OF THE INVENTION

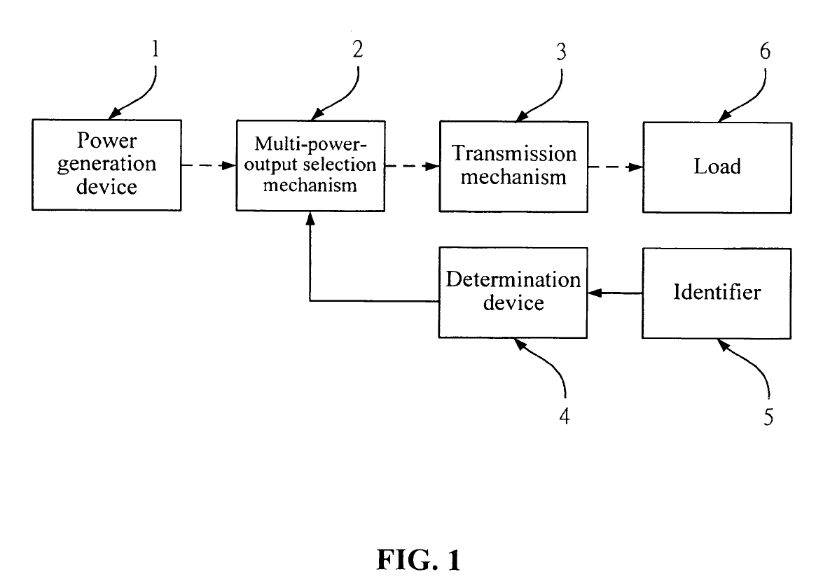

Referring to FIG. 1, a schematic relational diagram illustrating a power supply apparatus of the present invention is depicted. The schematic relational diagram includes a power generation device (1), a multi-power-output selection mechanism (2), a transmission mechanism (3), a determination device (4), an identifier (5) and a load (6). The power generation device (1) is a device capable of outputs the power, for example, a fuel cell, which has an energy converter of catalyst material for proceeding the electro-chemical reaction of hydrogen-rich fuel and oxygen fuel simultaneously and further producing electrical energy converted from the chemical energy. The multi-power-output selection mechanism (2) selects the power from the power generation device (1) for outputting the corresponding voltage based on the voltage magnitude of power required by the load (6). The transmission mechanism (3) has a power transmission line (31) for transmitting the power output from the multi-power output selection mechanism (2) to the load (6). The determination device (4) determines the electrical property of the identifier (5) and provides for the multi-power-output selection mechanism (2) a base of selecting the output voltage. The identifier (5) has a particular electrical property so as to define the electrical property corresponding to the output voltage selected by the multi-power-output selection mechanism (2); and the load (6) achieves the particular electrical operation by dissipating the input power.

The identifier (5) has an identification resistor (51) which resistance is defined as a specific output voltage value corresponding to the multi-power-output selection mechanism (2), thus when the determination device (4) is corresponding to the identifier (5) to output an electrical signal to the multi-power-output selection mechanism (2), the multi-power-output selection mechanism (2) selects a output voltage value corresponding to the electrical signal so that the power is output from the power generation device (I) based on the output voltage value and supplies this power with output voltage value to the load (6) through the transmission mechanism (3).

The determination device (4) determines the electrical signal of the identifier (5) and determines the power output specification corresponding to the electrical signal based on the default information. The power output specification can be voltage magnitude, current magnitude or power magnitude of the power required by the load (6), and the multi-power-output selection mechanism (2) outputs the power of the power generation device (1) with a specific voltage, a specific current or a specific power based on the power output specification.

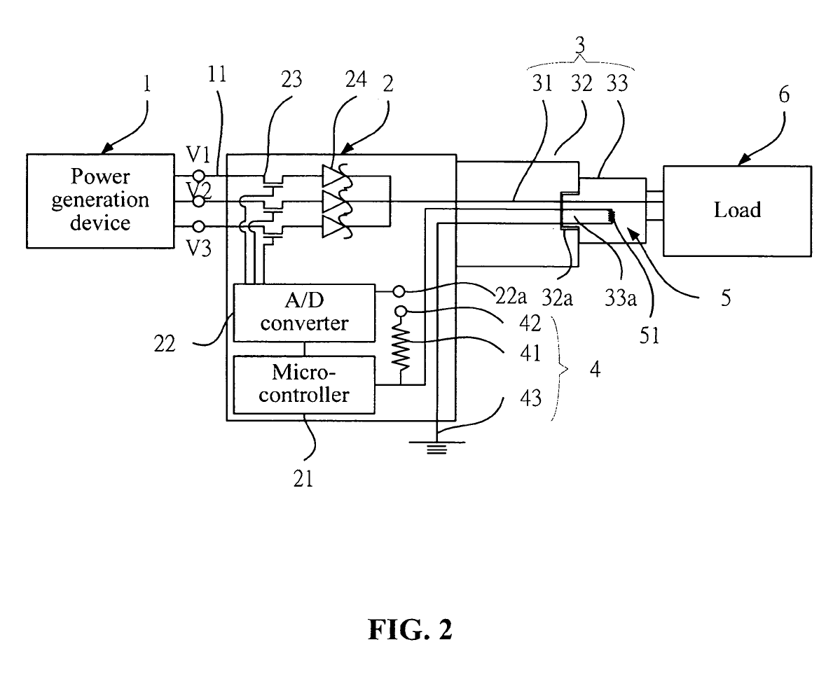

Referring to FIG. 2, a schematic block diagram illustrating an embodiment of the power supply apparatus of the present invention is depicted. The above-mentioned power generation device (I) further comprises a plurality of power output ports (11), each of which can output power with specific voltage wherein the specific voltage can be one of voltage V1, voltage V2 and voltage V3.

Besides, the multi-power-output selection mechanism (2) includes an A/D converter (21), a microcontroller (22), a plurality of switches (23) and a plurality of diodes (24), wherein the A/D converter (21) is electrically connected to the determination device (4) and the microcontroller (22), respectively. The determination device (4) outputs a voltage dividing value to the A/D converter (21) which converts into a digital signal and outputs it to the microcontroller (22), and provides the equivalent resistance of the identification resistor (51) of the identifier (5) calculated by the microcontroller (22) and determines the corresponding output voltage value based on the equivalent resistance. The microcontroller (22) is electrically connected to each of the switches (23) for inputting the control signal to each switch (23) and may selectively turn on or off the particular switch (23). Each of the plurality of switches (23) is electrically connected to the corresponding power output port (11) and the corresponding diode (24) so that any of the power output ports (11) of the power generation device (1) is selected to output the power with the specific voltage through On/OFF of the plurality of switches (23), and a plurality of power transmission channels for outputting the specific voltage is formed. The output end of the plurality of diodes (24) are electrically connected to form the power output terminal of the multi-power-output selection mechanism (2) and extended to the transmission mechanism (3) to form the power transmission line (31) of the transmission mechanism (3).

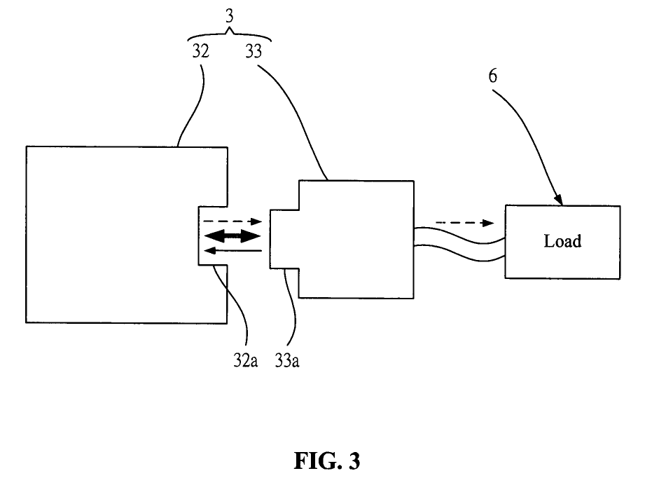

Referring to FIG. 3, a schematic block diagram illustrating another embodiment of the power supply apparatus of the present invention is depicted. The above-mentioned transmission mechanism (3) further comprises a first transmitter (32) and a second transmitter (33). The first transmitter (32) has a first engagement part (32a) and the second transmitter (33) has a second engagement part (33a), and the first engagement part (32a) and the second engagement part (33a) are mechanically engaged with one another so that the first engagement part (32a) and the second engagement part (33a) are configured to form a pair of connectors capable of electrical interface and mechanical coupling. The first transmitter (32) is electrically connected to the power output terminal of the multi-power-output selection mechanism (2) and the first engagement part (32a) forms another electrical connection terminal of the first transmitter (32); and the second engagement part (33a) forms one electrical connection terminal of the second transmitter (33) and another terminal of the second transmitter (33) provides the electrical connection to the load (6). Besides, referring back to FIG. 2, the first transmitter (32) can be securely provided on the multi-power-output selection mechanism (2).

The above-mentioned identifier (5) can be provided in the second transmitter (33) of the transmission mechanism (3).

Referring back to FIG. 2, the determination device (4) further comprises a reference resistor (41), a voltage input terminal (42) and a ground terminal (43). The reference resistor (41) is a resistor element, one end of the reference resistor (41) formed as the voltage input terminal (42) and the other end electrically connected to one end of the identifier (5) and the input end of the A/D) converter (21). The ground terminal (43) is electrically connected to the other end of the identifier (5). Therefore, through establishes the mapping table of the output voltage of the multi-power-output selection mechanism (2) on the resistance or voltage dividing value of the identifier (5) or any programmable mapping relationship, determines the voltage magnitude of power required by the load (6) based on the resistance or voltage dividing value of the identifier (5). Besides, in the above-mentioned mapping relationship, the resistance or voltage dividing value of the identifier (5) can be substituted for the equivalent electrical parameter to the resistance or voltage dividing value of the identifier (5).

The microcontroller (22) includes a plurality of input/output ports, and at least an input/output port is defined as a microcontroller voltage output terminal (22a), and the microcontroller voltage output terminal (22a) is electrically connected to the voltage input terminal (42) so that the voltage input terminal (42) has an input voltage Vcc, that is the microcontroller (22) provides a voltage source through the microcontroller voltage output terminal (22a) in the plurality of input/output ports, and the voltage source is supplied to the voltage input terminal (42) so that the voltage input terminal (42) has the input voltage Vcc.

In the above mentioned embodiment, since the resistance of the reference resistor (41) is defined as Ri, the equivalent resistance of the identifier (5) is defined as Rp, the input voltage of the voltage input terminal (42) as Vcc and the input voltage of the A/D converter (21) as Vctrl. Thus, the resistor dividing formula is obtained as below:

Vctrl=Vcc×(Rp/Ri+Rp)

and since the resistance Ri of the reference resistor (41) is constant, the digital control signal, converted by the A/D converter (21) from the voltage Vctrl, is output to the microcontroller (22) so that the microcontroller (22) may selectively turn on or off the particular switch (23) to achieve the determination of the output voltage control of the power generation device (I) based on the corresponding output voltage mapping relationship of the determination device (4). Therefore, it won't be happened in case of a so-called “wrong plug in a jack” (incorrect power supply) causes a damage to the circuit system under power supply.

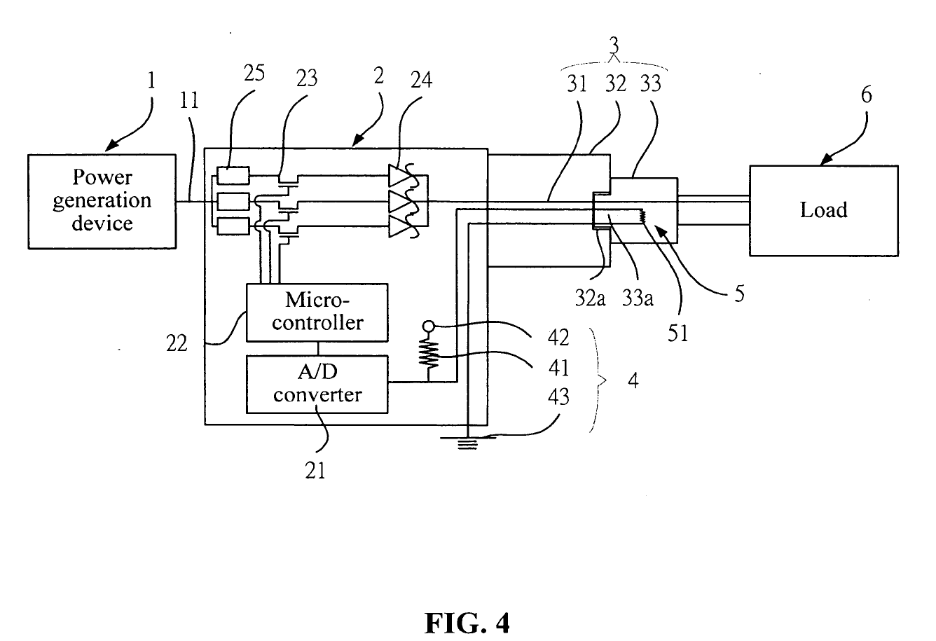

Referring to FIG. 4, a schematic block diagram illustrating a third embodiment of the power supply apparatus of the invention is depicted. The multi-power-output selection mechanism (2) further comprises a plurality of voltage converters (25), each of which is a DC-DC converter and sets an output voltage as a stable voltage corresponding to the load requirement. The voltage converters (25) can be a configuration of boost converter (BOOST), buck converter (BUCK) or single-ended primary inductor converter (SEPIC). Each voltage converter (25) is electrically connected in series with a corresponding switch (23), and each voltage converter (25) is electrically connected in parallel and also serially and electrically connected to the power output terminal of power generation device (1). Surely, for a circuit combination, the plurality of voltage converters (25) may have other equivalent configuration. For example, each voltage converter (25) can electrically connect in series between the corresponding switch (23) and diode (24), and it is characterized in that each set of the switches (23), diode (24) and voltage converter (25) can form an ON/OFF power transmission channel. When any of power transmission channels is turned on for outputting the power with specific voltage, the object that multi-power-output selection mechanism (2) selects the output voltage corresponding to the determination device (4) is achieved.

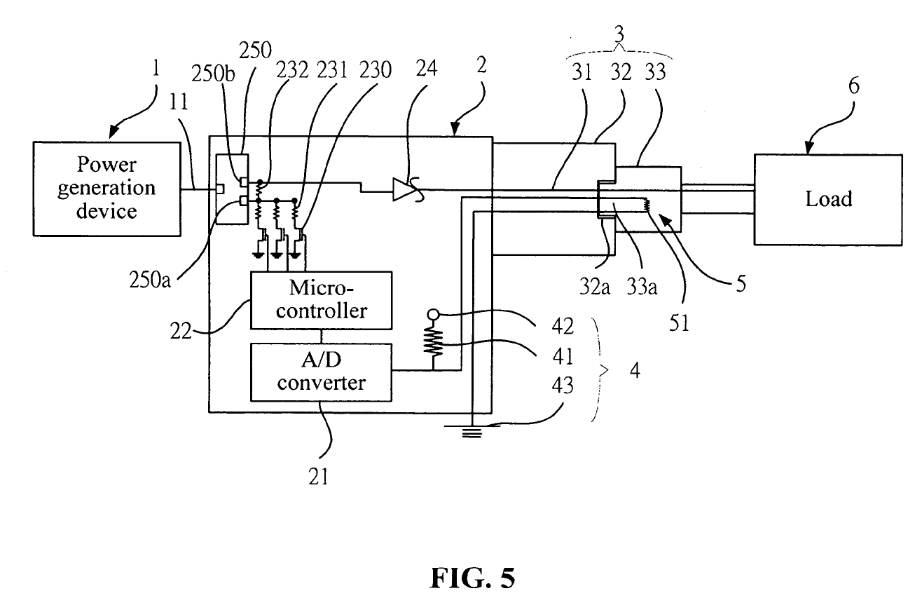

Referring to FIG. 5, a schematic block diagram illustrating a fourth embodiment of the power supply apparatus of the invention is depicted. The multi-power-output selection mechanism (2) further comprises a voltage converter (250) which is a DC-DC converter and can be a configuration of BOOST, BUCK or SEPIC, and the electrical output terminal (250b) of the voltage converter (250) is electrically connected to a feedback resistor (232) and then serially connected to the plurality of switches (230) and resistor (231) connected in parallel. Each of the plurality of switches (230) is electrically connected in series to one resistor (231), and one end of the feedback resistor (232) connected with each set of serially and electrically connection of the switch (230) and resistor (231) is electrically connected to the feedback voltage contact (250a) of the voltage converter (250). Each switch (230) is electrically connected in series with the corresponding resistor (231) and one end of the switch (230) is connected to the ground so that each set of serially and electrically connection of the switch (230) and the resistor (231) is electrically connected in parallel to one another. Each set of serially and electrically connection of the switch (230) and resistor (231) can be configured to form an equivalent resistor so as to change the output voltage of the voltage converter (250) when each of the plurality of switches (230) is turned on or off. Thus, when the digital control signal converted from the input voltage Vctrl by the A/D converter (21) is output to the microcontroller (22), the microcontroller (22) may selectively turn on or off the particular switch (230) based on the output voltage mapping relationship of the determination device (4) so as to determine the output control for the specific output voltage of the power generation device (1).

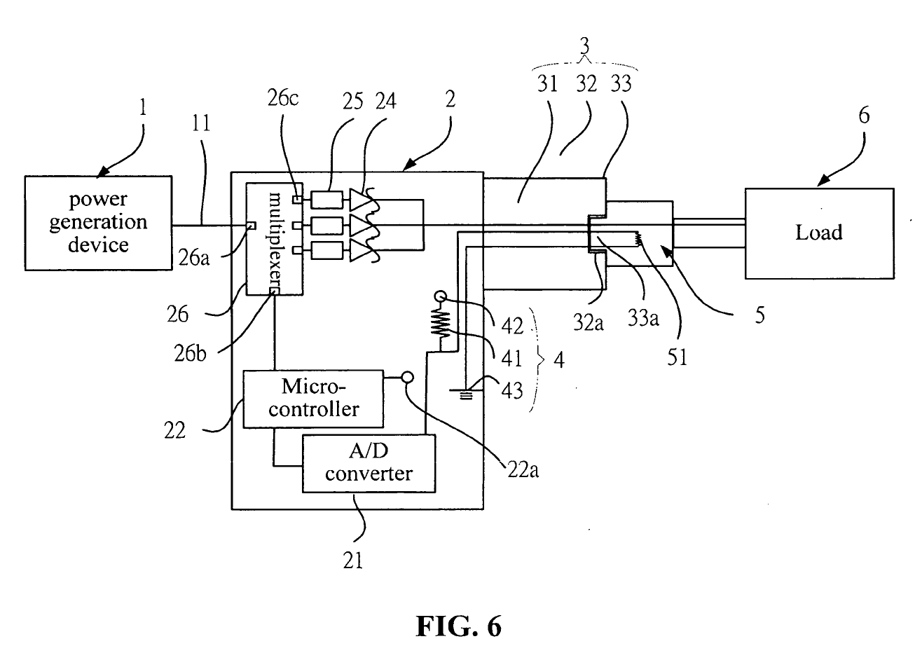

Referring to FIG. 6, a schematic block diagram illustrating a fifth embodiment of the power supply apparatus of the invention is depicted. In the above-mentioned embodiments, those switches can be replaced by a multiplexer (26). The multiplexer (26) has a power input terminal (26a) electrically connected to the power generation device (1) for inputting the output power of the power generation device (1), and the multiplexer (26) has a control input terminal (26b) electrically connected to the microcontroller (22) for inputting the control signal of the microcontroller (22) so that a plurality of power output terminals (26c) of the multiplexer (26) can be selected by the control signal to determine which power transmission channel outputs the power with specific voltage and meets the power specification required by the load (6). Besides, each of the plurality of voltage converters (25) is electrically connected in series to one power output terminal (26c) of the multiplexer (26) correspondingly, so as to form the plurality of power transmission channels and output the power with specific voltage for each power transmission channel.

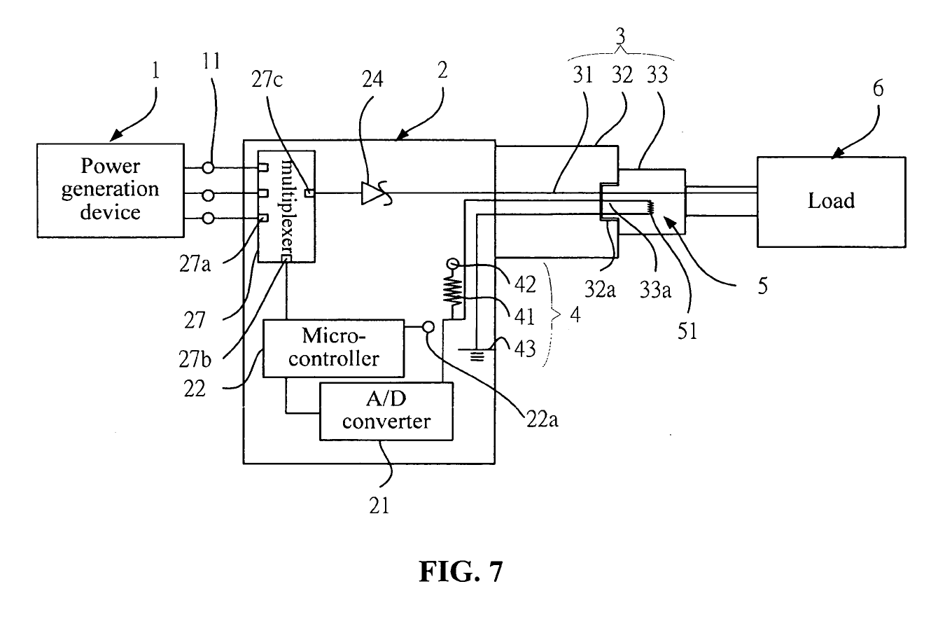

Referring to FIG. 7, a schematic block diagram illustrating a sixth embodiment of the power supply apparatus of the invention is depicted. Those switches disclosed in the embodiment as shown in FIG. 2 can be replaced by a multiplexer (27). The multiplexer (27) includes a plurality of power input terminals (27a), each of which is electrically connected to each power output port (11) of the power generation device (1) for inputting the power with varying voltages output from the power generation device (1). The multiplexer (27) has a control input terminal (27b) is electrically connected to the microcontroller (22) for inputting the control signal of the microcontroller (22), and the multiplexer (27) has a power output terminal (27c) for electrically connecting with the power transmission line (31) of the transmission mechanism (3). Therefore, the plurality of power input terminals (27a) can be selected by the control signal to determine which power transmission channel outputs the power with specific voltage to meet the power specification required by the load (6).

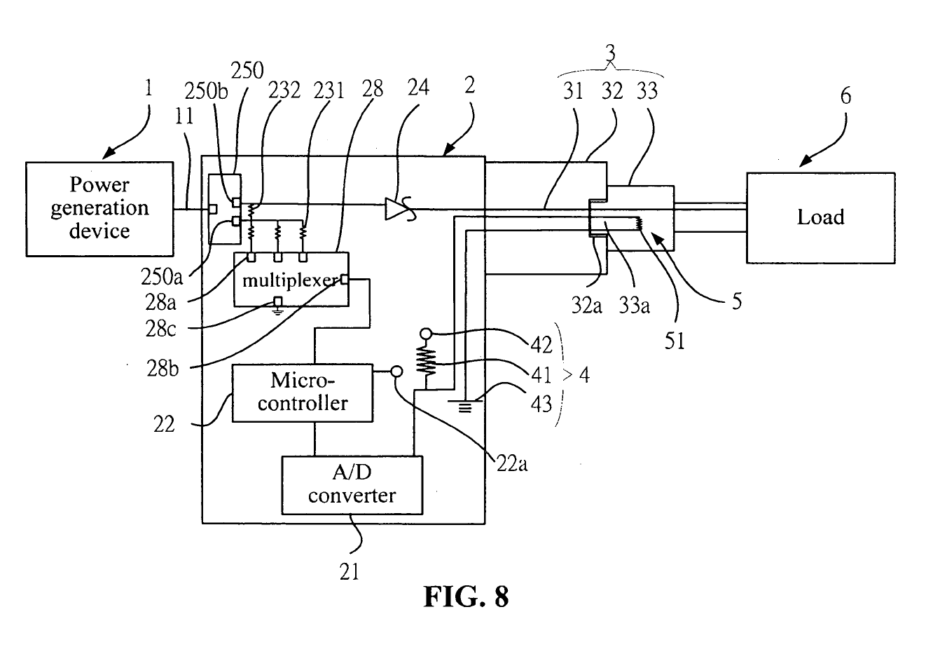

Referring to FIG. 8, a schematic block diagram illustrating a seventh embodiment of the power supply apparatus of the invention is depicted. Those switches disclosed in the fourth embodiment as shown in FIG. 5 can be replaced by a multiplexer (28) in the seventh embodiment as shown in FIG. 8. The multiplexer (28) includes a plurality of connection terminals (28a), a control input terminal (28b) and a ground terminal (28c) and selects one of the plurality of connection terminals (28a) to electrically connect to the ground terminal (28c) based on the signal received from the control input terminal (28b), and the control input terminal (28b) is electrically connected to the microcontroller (22) for inputting the control signal of the microcontroller (22) and the ground terminal (28c) is connected to the ground. The multi-power-output selection mechanism (2) further comprises a voltage converter (250) which is a DC-DC converter and can be a configuration of BOOST, BUCK or SEPIC. An electrical output terminal (250b) of the voltage converter (250) is electrically connected to the feedback resistor (232) and then serially connected to a plurality of resistors (231) connected in parallel. One end of each resistor (231) is electrically connected to a feedback voltage contact (250a) of the voltage converter (250) and the other end is electrically connected to a corresponding connection terminal (28a) of the multiplexer (28). The plurality of resistors (231) can be configured to form an equivalent resistor so as to change the output voltage of the voltage converter (250) when the multiplexer (28) selects the connection terminals (28a) for electrically connecting with the ground terminal (28c). Therefore, when the digital control signal converted from the input voltage Vctrl by the A/D converter (21) is output to the control input terminal (28b) of the multiplexer (28), the multiplexer (28) may have selectively electrical connected to the connection terminals (28a) and the ground terminal (28c) so as to determine the output control for the output voltage of the power generation device (1).

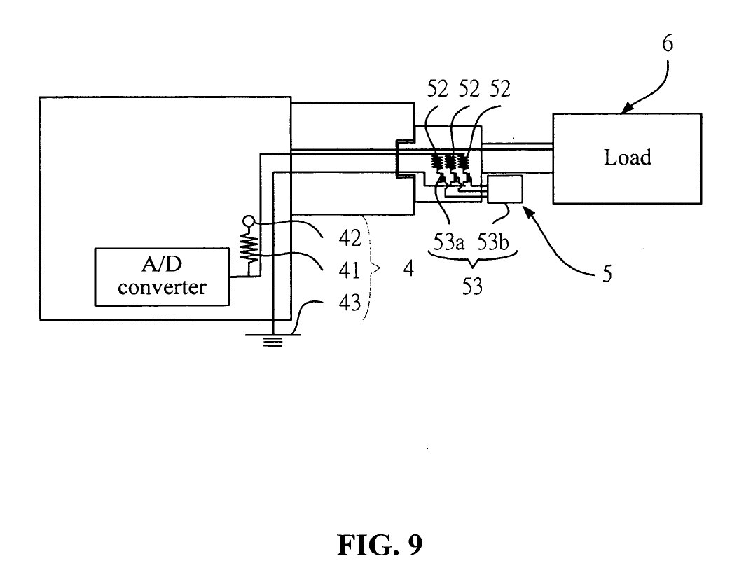

Referring to FIG. 9, a schematic block diagram illustrating an eighth embodiment of the power supply apparatus of the invention is depicted. In the above-mentioned embodiments, the identifier (5) further comprises a plurality of identification resistors (52) and a selection means of identifier (53). The plurality of identification resistors (52) is electrically connected in parallel, and one end of each identification resistor (52) is electrically connected in series with the reference resistor (41) and the other end is electrically connected in series with the ground terminal (43). Besides, the selection means of identifier (53) is to select electrical conduction for each identification resistor (52) so that the selected identification resistor (52) may form an equivalent resistor which changes the equivalent resistance Rp of the above mentioned identifier (5) to meet the power specification required by the load (6) and accordingly to modulate the equivalent resistance Rp of the identifier (5).

Each switch of identifier (53a) can be a circuit consisted of a switching means of identifier (53b) coupled with a plurality of switches of identifier (53a). Each switch of identifier (53a) is electrically connected in series with a corresponding identification resistor (52), and selects ON/OFF of the switch of identifier (53a) through the switching means of identifier (53b) so that the selection means of identifier (53) can be adjustable to change the equivalent resistance Rp of the identifier (5).

In the eighth embodiment of the power supply apparatus of the present invention, the object of the identifier (5) having a plurality of identification resistors (52) is to integrate multiple transmission voltages, the relationship of Vctrl, Vcc, Rpi and Ri is obtained from the formula: Vctrl=Vcc×(Rpi/Ri+Rpi), where Rpi is an equivalent resistance for each resistance Rp. Besides, each identification resistor (52) may have a different resistance.

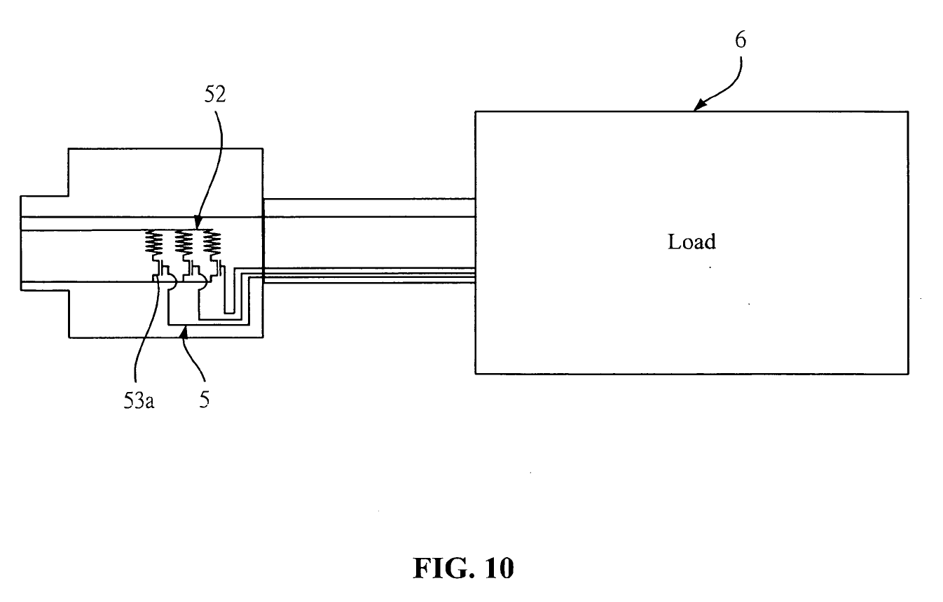

Referring to FIG. 10, a schematic block diagram illustrating a ninth embodiment of the power supply apparatus of the invention is depicted. In the embodiment as shown in FIG. 9, the switching means of identifier (53b) in the selection means of identifier (53) of the identifier (5) can be fulfilled by the load (6). As an example for one embodiment, the load (6) is a notebook computer in which the switching means of identifier (53b) is provided, and the switching means of identifier (53b) disclosed in the embodiment shown in FIG. 9 can be fulfilled through an algorithm calculator of the load (6) or any programming means.

In the above mentioned embodiments, the A/D converter (21) can receive the input analog signal (has the resistance Vctrl) and determine that the input signal falls into which of the plurality of equal-divided intervals between the voltage Vcc at the input terminal and the voltage at the ground terminal for controlling the multi-power-output switch (23) so as to convert the input analog signal to the controllable multi-power-output digital signal.

The above-mentioned preferred embodiments of the present invention are not meant to limit the scope of the present invention. The description of the present invention should be understood by those skilled in the art. Moreover, any changes or modifications or the equivalent thereof that can be made without departing from spirit of the present invention should be protected by the following claims.

What is claimed is:

1. A power supply apparatus for selecting select a power generation device for outputting power in the form of varying voltage therefrom, comprising:
a power generation device including a plurality of power output ports, each of power output ports outputting a power with specific voltage, respectively;
an identifier;
a determination device for determining an electrical property of the identifier and outputting an electrical signal corresponding to the electrical property;
a multi-power-output selection mechanism, which includes a plurality of power transmission channels and power transmission channel selection means, the power transmission channel selection means selecting the corresponding power transmission channel based on the electrical signal output from the determination device; and
a transmission mechanism for transmitting the power output from the multi-power-output selection mechanism;
wherein the multi-power-output selection mechanism is electrically connected to the determination device and the transmission mechanism so that the electrical signal output from the determination device is transmitted to the multi-power-output selection mechanism, the voltage output selection means transmitting the specific output voltage to the transmission mechanism through the selected power transmission channel.

2. The power supply apparatus according to claim 1, wherein the power transmission channel selection means of the multi-power-output selection mechanism further comprises a plurality of switches which are electrically connected in series with a corresponding power transmission channel respectively, the multi-power-output selection mechanism selecting an ON or OFF state for the corresponding switch based on the electrical signal output from the determination device so that the voltage output selection means selecting the corresponding power transmission channel.

3. The power supply apparatus according to claim 2, wherein the determination device further comprises an A/D converter for converting the electrical signal output from the determination device into a digital control signal and outputting the digital control signal; the power transmission channel selection means of the multi-power-output selection mechanism further comprising a microcontroller electrically connected to the A/D converter and the voltage output selection means and the microcontroller selecting an ON or OFF state for each switch based on the digital control signal output from the A/D converter.

4. The power supply apparatus according to claim 3, wherein the power generation device is a fuel cell.

5. The power supply apparatus according to claim 1, wherein the power transmission channel selection means of the multi-power-output selection mechanism further comprises a multiplexer, the multiplexer comprising:
a plurality of power input terminals electrically connected to the power supply apparatus, each of which being electrically connected to a corresponding power transmission channel, for inputting the output power of the power supply apparatus; and
a power output terminal;
wherein the multi-power-output selection mechanism selects an ON or OFF state for each of the power input terminals and the corresponding power output terminals based on the electrical signal output from the determination device so that the voltage output selection means selects the corresponding power transmission channel.

6. The power supply apparatus according to claim 5, wherein the multiplexer further comprises a control input terminal; the determination device further comprising an A/D converter for converting the electrical signal output from the determination device into a digital control signal and outputting the digital control signal; and the power transmission channel selection means of the multi-power-output selection mechanism further comprising a microcontroller electrically connected to the A/D converter and the control input terminal of the multiplexer respectively; the microcontroller selecting an ON or OFF state for each power input terminal and the corresponding power output terminals based on the digital control signal output from the A/D converter so that the voltage output selection means selecting the corresponding power transmission channel.

7. The power supply apparatus according to claim 6, wherein the power generation device is a fuel cell.

8. The power supply apparatus according to claim 1, wherein the transmission mechanism further comprises:
a first transmitter comprising a first engagement part, the first transmitter being electrically connected to the power output terminal of the multi-power-output selection mechanism and the first engagement part forming another electrical connection terminal of the first transmitter; and
a second transmitter comprising a second engagement part, the second engagement part forming one electrical connection terminal of the second transmitter and another terminal of the second transmitter providing the electrical connection;
wherein the first engagement part is mechanically engaged with the second engagement part, and the first engagement part and the second engagement part being configured to form a pair of connectors capable of electrical interface and mechanical coupling.

9. The power supply apparatus according to claim 8, wherein the identifier is provided in the second transmitter of the transmission mechanism.

10. The power supply apparatus according to claim 9, wherein the identifier at least comprises an identification resistor, the resistor having a specific resistance which defines a corresponding signal to a specific output voltage.

11. The power supply apparatus according to claim 9, wherein the determination device comprises a plurality of identification resistors electrically connected with each other in parallel, each of the plurality of identification resistors having a specific resistance, and the equivalent resistance configured by the plurality of identification resistors defining a corresponding signal to the specific output voltage.

12. The power supply apparatus according to claim 11, wherein the identifier further comprises a selection means of identifier for selecting electrical conduction for each of the identification resistors so that the selected identification resistor with electrical conduction being configured to form an equivalent resistor.

13. The power supply apparatus according to claim 12, wherein the selection means of identifier comprises a plurality of switches of identifier, and each of the switches is an electronic switch.

14. The power supply apparatus according to claim 13, wherein the transmission mechanism is electrically connected to an electronic device; and a switching means of identifier in the identification resistor selection means of the identifier being provided in the electronic device.

15. The power supply apparatus according to claim 14, wherein one end of each of the identification resistors is electrically connected to the same reference resistor and the other end is electrically connected to a ground terminal.

16. The power supply apparatus according to claim 15, wherein the selection means of identifier further comprises a switching means of identifier for selecting to turn on/off the switch of identifier to modulate the equivalent resistance of the identification resistor.

17. The power supply apparatus according to claim 15, wherein the voltage at the input terminal of the reference resistor is provided by the microcontroller.

18. A power supply apparatus for selecting a power generation device for outputting power in the form of varying voltage therefrom, comprising:
a power generation device including a power output port, the power output port outputting a power with specific voltage;
an identifier;
a determination device for determining an electrical property of the identifier and providing an electrical signal corresponding to the electrical property;
a multi-power-output selection mechanism, which includes a plurality of power transmission channels and power transmission channel selection means, the power transmission channel selection means selecting the corresponding power transmission channel based on the determination device, the multi-power-output selection mechanism further comprising a plurality of voltage converters, each of the voltage converters being electrically connected in series with a corresponding power transmission channel for converting power transmitted from each power transmission channel into varying specific output voltage; and
a transmission mechanism for transmitting the power output from the multi-power-output selection mechanism;
wherein the multi-power-output selection mechanism is electrically connected to the determination device and the transmission mechanism, and based on the electrical signal output from the determination device, enabling the voltage output selection means to select the corresponding power transmission channel to transmit the specific output voltage to the transmission mechanism.

19. The power supply apparatus according to claim 18, wherein the power transmission channel selection means of the multi-power-output selection mechanism further comprises a plurality of switches which are electrically connected in series with a corresponding power transmission channel respectively, the multi-power-output selection mechanism selecting an ON and OFF state for the corresponding switch based on the electrical signal output from the determination device so that the voltage output selection means selecting the corresponding power transmission channel.

20. The power supply apparatus according to claim 19, wherein the determination device further comprises an A/D converter for converting the electrical signal output from the determination device into a digital control signal and outputting the digital control signal; the power transmission channel selection means of the multi-power-output selection mechanism further comprising a microcontroller electrically connected to the A/D converter and the voltage output selection means, and the microcontroller selecting an ON or OFF state for each switch based on the digital control signal output from the A/D converter.

21. The power supply apparatus according to claim 20, wherein the power generation device is a fuel cell.

22. The power supply apparatus according to claim 18, wherein the power transmission channel selection means of the multi-power-output selection mechanism further comprises a multiplexer, the multiplexer comprising:
a power input terminal electrically connected to the power supply apparatus; and
a plurality of power output terminals, each of which being electrically connected to a corresponding voltage converter, for converting the output power of the power supply apparatus into the predetermined specific voltage output;
wherein the multi-power-output selection mechanism selects an ON or OFF state for the power input terminal and the corresponding power output terminal based on the electrical signal output from the determination device so that the voltage output selection means selects the corresponding power transmission channel.

23. The power supply apparatus according to claim 22, wherein the multiplexer further comprises a control input terminal; the determination device further comprising an A/D converter for converting the electrical signal output from the determination device into a digital control signal and outputting the digital control signal; and the power transmission channel selection means of the multi-power-output selection mechanism further comprising a microcontroller electrically connected to the A/D converter and the control input terminal of the multiplexer respectively; and the microcontroller selecting an ON or OFF state for the power input terminal and the corresponding power output terminal based on the digital control signal output from the A/D converter so that the voltage output selection means selecting the corresponding power transmission channel.

24. The power supply apparatus according to claim 23, wherein the power generation device is a fuel cell.

25. The power supply apparatus according to claim 18, wherein the transmission mechanism further comprises:
a first transmitter comprising a first engagement part, the first transmitter being electrically connected to the power output terminal of the multi-power-output selection mechanism and the first engagement part forming another electrical connection terminal of the first transmitter; and
a second transmitter comprising a second engagement part, the second engagement part forming one electrical connection terminal of the second transmitter and another terminal of the second transmitter providing the electrical connection; wherein the first engagement part is mechanically engaged with the second engagement part, and first engagement part and the second engagement part being configured to form a pair of connectors capable of electrical interface and mechanical coupling.

26. The power supply apparatus according to claim 25, wherein the identifier is provided in the second transmitter of the transmission mechanism.

27. The power supply apparatus according to claim 26, wherein the identifier at least comprises an identification resistor, the resistor having a specific resistance which defines a corresponding signal to a specific output voltage.

28. The power supply apparatus according to claim 27, wherein the determination device comprises a plurality of identification resistors electrically connected with each other in parallel, each of the plurality of identification resistors having a specific resistance and the equivalent resistance configured by the plurality of identification resistors defining a corresponding signal to the specific output voltage.

29. The power supply apparatus according to claim 18, wherein the identifier further comprises an selection means of identifier for selecting electrical conduction for each of the identification resistors so that the selected identification resistor with electrical connection being configured to form an equivalent resistor.

30. The power supply apparatus according to claim 29, wherein the selection means of identifier comprises a plurality of switches of identifier, and each of the switches is an electronic switch.

31. The power supply apparatus according to claim 30, wherein the transmission mechanism is electrically connected to an electronic device; and a switching means of identifier in the identification resistor selection means of the identifier being provided in the electronic device.

32. The power supply apparatus according to claim 31, wherein one end of each of the identification resistors is electrically connected to the same reference resistor and the other end is electrically connected to a ground terminal.

33. The power supply apparatus according to claim 32, wherein the selection means of identifier further comprises a switching means of identifier for selecting to turn on/off the switch of identifier to modulate the equivalent resistance of the identification resistor.

34. The power supply apparatus according to claim 33, wherein the selection means of identifier further comprises a switching means of identifier for selecting to turn on/off the switch of identifier to modulate the equivalent resistance of the identification resistor.

35. The power supply apparatus according to claim 33, wherein the voltage at the input terminal of the reference resistor is provided by the microcontroller.

36. A power supply apparatus for selecting a power generation device for outputting power in the form of varying voltage therefrom, comprising:
a power generation device including a power output port, the power output port outputting a power with specific voltage;
an identifier;
a determination device for determining an electrical property of the identifier and providing an electrical signal corresponding to the electrical property;
a multi-power-output selection mechanism, which includes a power transmission channel and a power output voltage selection means, the power transmission channel selection means selecting the corresponding power transmission channel based on the determination device, the multi-power-output selection mechanism further comprising a voltage converter which makes conversion of variable voltages, for converting the power output from the power generation device into a output power with a plurality of specific output voltages; and
a transmission mechanism for transmitting the power output from the multi-power-output selection mechanism;
wherein the multi-power-output selection mechanism is electrically connected to the determination device and the transmission mechanism, and based on the electrical signal output from the determination device, enabling the voltage output selection means to select the corresponding output voltage of the voltage converter to the transmission mechanism.

37. The power supply apparatus according to claim 36, wherein the electrical output terminal of the voltage converter is electrically connected to a voltage dividing circuit which comprises a plurality of switches, a plurality of first current dividing passageways and at least one second current dividing passageway, the plurality of switches operatively selecting ON or OFF state for each of the plurality of first current dividing passageways, and each of the plurality of first current dividing passageways and the second current dividing passageways being at least electrically connected in series with a resistor, one end of the plurality of first current dividing passageways being electrically and serially connected to a ground terminal, and the other end of the plurality of first current dividing passageways and one end of the second current dividing passageway being electrically connected to a reference voltage terminal simultaneously, the other end of the second current dividing passageway being electrically connected to the voltage output terminal;
wherein the reference voltage terminal is provided to supply a constant voltage source and the controller is provided to control the channel selection means for selecting the ON or open circuit state for each of the plurality of first current dividing passageways.

38. The power supply apparatus according to claim 37, wherein the determination device further comprises an A/D converter for converting the electrical signal output from the determination device into a digital control signal and outputting the digital control signal; and the power transmission channel selection means of the multi-power-output selection mechanism further comprising a microcontroller electrically connected to the A/D converter and the voltage output selection means and the microcontroller selecting an ON and OFF state for each switch based on the digital control signal output from the A/D converter.

39. The power supply apparatus according to claim 38, wherein the power generation device is a fuel cell.

40. The power supply apparatus according to claim 36, wherein the power transmission channel selection means of the multi-power-output selection mechanism further comprises a multiplexer, the multiplexer comprising:
a plurality of connection terminals, each of which being electrically connected to at least a resistor and to the power supply apparatus; and
a ground terminal;
wherein the multi-power-output selection mechanism selects an ON and OFF state for one of the plurality of connection terminals and the ground terminal of the multiplexer based on the electrical signal output from the determination device.

41. The power supply apparatus according to claim 40, wherein the multiplexer further comprises a control input terminal; the determination device further comprising an A/D converter for converting the electrical signal output from the determination device into a digital control signal and outputting the digital control signal; and the power transmission channel selection means of the multi-power-output selection mechanism further comprising a microcontroller electrically connected to the A/D converter and the control input terminal of the multiplexer respectively, and the microcontroller selecting an ON and OFF state for each connection terminal and the corresponding ground terminal based on the digital control signal output from the A/D converter.

42. The power supply apparatus according to claim 41, wherein the power generation device is a fuel cell.

43. The power supply apparatus according to claim 36, wherein the transmission mechanism further comprises:
a first transmitter comprising a first engagement part, the first transmitter being electrically connected to the power output terminal of the multi-power-output selection mechanism and the first engagement part forming another electrical connection terminal of the first transmitter; and
a second transmitter comprising a second engagement part, the second engagement part forming one electrical connection terminal of the second transmitter and another terminal of the second transmitter providing the electrical connection;
wherein the first engagement part is mechanically engaged with the second engagement part, and first engagement part and the second engagement part being configured to form a pair of connectors capable of electrical interface and mechanical coupling.

44. The power supply apparatus according to claim 43, wherein the identifier is provided in the second transmitter of the transmission mechanism.

45. The power supply apparatus according to claim 44, wherein the identifier at least comprises an identification resistor, the resistor having a specific resistance which defines a corresponding signal to a specific output voltage.

46. The power supply apparatus according to claim 45, wherein the determination device comprises a plurality of identification resistors electrically connected with each other in parallel, each of the plurality of identification resistors having a specific resistance and the equivalent resistance configured by the plurality of identification resistors defining a corresponding signal to the specific output voltage.

47. The power supply apparatus according to claim 46, wherein the identifier further comprises an selection means of identifier for selecting electrical conduction for each of the identification resistors so that the selected identification resistor with electrical connection being configured to form an equivalent resistor.

48. The power supply apparatus according to claim 47, wherein the selection means of identifier comprises a plurality of switches of identifier, and each of the switches is an electronic switch.

49. The power supply apparatus according to claim 48, wherein the transmission mechanism is electrically connected to an electronic device; and a switching means of identifier in the identification resistor selection means of the identifier being provided in the electronic device.

50. The power supply apparatus according to claim 49, wherein one end of each of the identification resistors is electrically connected to the same reference resistor and the other end is electrically connected to a ground terminal.

51. The power supply apparatus according to claim 50, wherein the selection means of identifier further comprises a switching means of identifier for selecting to turn on/off the switch of identifier to modulate the equivalent resistance of the identification resistor.

52. The power supply apparatus according to claim 50, wherein the voltage at the input terminal of the reference resistor is provided by the microcontroller.
